(19) United States
(12) Patent Application Publication
(10) Pub. No.: US 2011/0258389 A1
(43) Pub. Date: Oct. 20, 2011

(54) VIRTUAL STORAGE METHOD AND DEVICE

(75) Inventors: Yibin LI, Chengdu (CN); Qingchao LUO, Chengdu (CN); Xiaohua LI, Chengdu (CN)

(73) Assignee: CHENGDU HUAWEI SYMANTEC TECHNOLOGIES CO., LTD., Chengdu (CN)

(21) Appl. No.: 13/171,844

(22) Filed: Jun. 29, 2011

Related U.S. Application Data
(63) Continuation of application No. PCT/CN2009/074342, filed on Sep. 30, 2009.

(30) Foreign Application Priority Data
Dec. 29, 2008 (CN) 200810188018.3

(51) Int. Cl. G06F 12/08

(52) U.S. Cl. 711/114; 711/E12.019

(57) ABSTRACT

A virtual storage method and a device are disclosed. The virtual storage method includes: obtaining a volume management mode of a Logical Unit Number (LUN) from a storage array and recording the volume management mode into stitch data; and constructing a virtual LUN according to the LUN and the stitch data, and mapping the virtual LUN to a host to enable read/write access; and modifying a destination address of an Input/Output (I/O) data packet delivered by the host according to the stitch data after receiving the I/O data packet, delivering the I/O data packet to the virtual LUN, and delivering the I/O data packet which has been delivered to the virtual LUN to the storage array according to the stitch data, where an address of the storage array to which the I/O data packet is delivered is the same as the destination address of the I/O data packet before the destination address of the I/O data packet is modified.

### CROSS-REFERENCE TO RELATED APPLICATIONS

This application is a continuation of International Application No. PCT/CN2009/074342, filed on Sep. 30, 2009, which claims priority to Chinese Patent Application No. 200810188018.3, filed on Dec. 29, 2008, both of which are hereby incorporated by reference in their entireties.

### FIELD OF THE INVENTION

The present invention relates to the field of network storage technologies, and in particular, to a virtual storage method and a device.

### BACKGROUND OF THE INVENTION

With the continuous increase of the demand for data storage, the storage mode evolves from a built-in hard disk in a server host to a dedicated storage device, namely, network storage. The mainstream of the network storage is Storage Attach Network (SAN). In an SAN architecture, an SAN storage device (storage disk array) is divided into Logical Unit Number (LUNs) as required, and the LUNs are mapped to the server host so that the LUNs are available to the server host.

Host architectures differ, operating systems differ, and storage devices are governed by no uniform standard. Therefore, after a period of using the storage device, it is rather complicated to re-plan the logical environment of the existing storage device: on one hand, it is required to ensure less or even no interruption of the existing services that generate data, and on the other hand, it is required to ensure security of storage data, or more devices, time and network bandwidth are required for migrating data.

To meet such requirements, a storage virtualization solution is generally adopted in the prior art. The storage virtualization device is located on a network layer of the SAN architecture (between the server host and the SAN storage device), and takes over an original Input/Output (I/O) stream. In an uplink direction, the storage virtualization device may be connected with multiple server hosts, and in a downlink direction, the storage virtualization device may be connected with multiple SAN storage devices, so that the difference between the server host and the storage disk array is screened. However, the existing storage virtualization device is unable to screen the difference between server hosts, and unable to screen the difference between volume management modes of different system platforms.

### SUMMARY OF THE INVENTION

Embodiments of the present invention provide a virtual storage method and a device, so as to achieve storage convergence and screen difference between different hosts.

In an aspect, an embodiment of the present invention provides a virtual storage method, where the virtual storage method includes:

obtaining a volume management mode of an LUN from a storage array and recording the volume management mode in stitch data;

constructing a virtual LUN according to the LUN and the stitch data, and mapping the virtual LUN to a host to enable read/write access; and

modifying a destination address of an I/O data packet delivered by the host according to the stitch data after receiving the I/O data packet, delivering the I/O data packet to the virtual LUN, and delivering the I/O data packet delivered to the virtual LUN to the storage array according to the stitch data, where an address of the storage array to which the I/O data packet is delivered is the same as the destination address of the I/O data packet before the modification.

In another aspect, an embodiment of the present invention provides a virtualization device, where the virtualization device includes:

an obtaining module, configured to obtain a volume management mode of an LUN from a storage array;

a recording module, configured to record the volume management mode obtained by the obtaining module in stitch data;

a stitching module, configured to construct a virtual LUN according to the LUN and the stitch data obtained by the recording module, and map the virtual LUN to a host to enable read/write access; and

an I/O data packet processing module, configured to modify a destination address of an I/O data packet delivered by the host according to the stitch data obtained by the recording module after receiving the I/O data packet, deliver the I/O data packet to the virtual LUN, and deliver the I/O data packet delivered to the virtual LUN to the storage array according to the stitch data, where an address of the storage array to which the I/O data packet is delivered is the same as the destination address of the I/O data packet before the modification.

Compared with the prior art, the embodiments of the present invention have at least the following benefits: through the embodiments of the present invention, the virtualization device records the volume management mode of the LUN from the storage array into the stitch data, constructs the virtual LUN according to the LUN and the stitch data, and maps the virtual LUN to the host to enable the read/write access. After receiving the I/O data packet delivered by the host, the virtualization device modifies the destination address of the I/O data packet according to the stitch data, delivers the I/O data packet to the virtual LUN, and delivers the I/O data packet delivered to the virtual LUN to the storage array according to the stitch data, where the address of the storage array to which the I/O data packet is delivered is the same as the destination address of the I/O data packet before the modification. The embodiments of the present invention achieve storage convergence, and may screen the difference between different hosts and screen the difference between volume management modes from different system platforms.

### BRIEF DESCRIPTION OF THE DRAWINGS

To describe the technical solutions of the embodiments of the present invention more clearly, the following outlines the accompanying drawings involved in the embodiments. Apparently, the accompanying drawings outlined below are only some embodiments of the present invention, and persons of ordinary skill in the art can derive other drawings from such accompanying drawings without any creative effort.

FIG. 1 is a flowchart of a virtual storage method according to an embodiment of the present invention;

FIG. 2 is a schematic diagram of volume management modes of different operating systems;

FIG. 3 is a schematic diagram of I/O data packet processing according to an embodiment of the present invention;

FIG. 4 is a structural diagram of a virtualization device according to an embodiment of the present invention; and

FIG. 5 is a structural diagram of another virtualization device according to an embodiment of the present invention.

### DETAILED DESCRIPTION OF THE EMBODIMENTS

The following detailed description is given in conjunction with the accompanying drawings in order to provide a clear understanding of the present invention. Evidently, the drawings and the detailed description are merely representative of particular embodiments of the present invention rather than all embodiments. All other embodiments, which can be derived by persons of ordinary skill in the art from the embodiments given herein without any creative effort, shall fall within the protection scope of the present invention.

An embodiment of the present invention provides a virtual storage method, which can mask off difference between different hosts and difference between different storage arrays, and can protect original data of a user, so that neither the content of the original data nor the storage location of the original data is changed; the original networking mode and data storage mode may be recovered when the virtualization device is unplugged from the existing storage network, so that the original storage environment is not affected; and other functional software does not need to be installed on a server host of the original network, so that resources of the server host are not occupied.

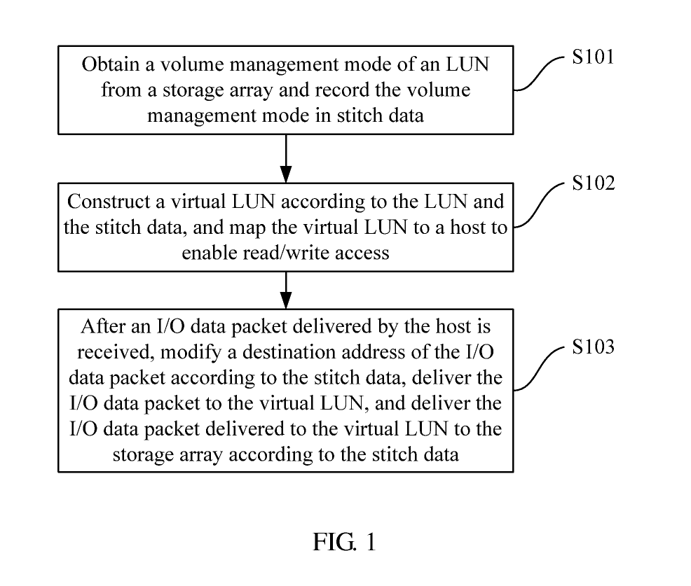

FIG. 1 is a flowchart of a virtual storage method according to an embodiment of the present invention, which includes:

Step S101: Obtain a volume management mode of an LUN from a storage array and record the volume management mode in stitch data.

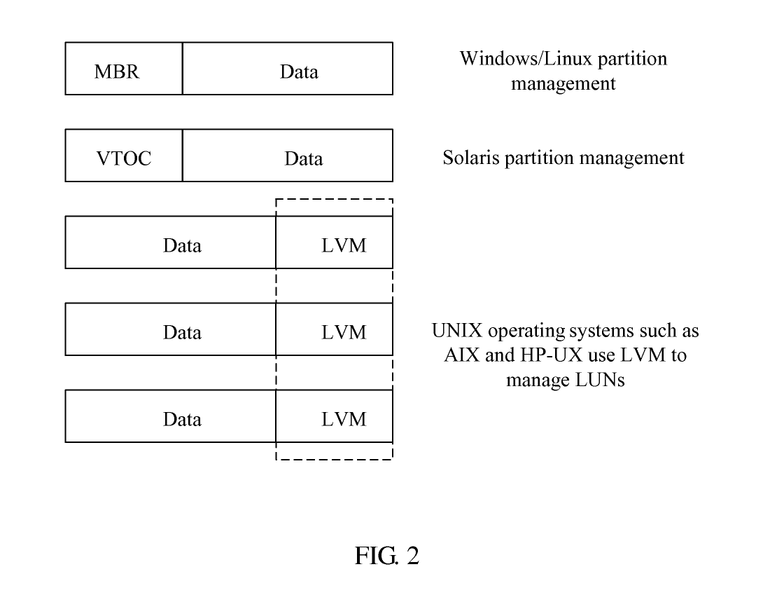

Operating system platforms of mainstream server hosts generally provide volume (disk) management modes. Volume management modes of different operating systems are incompatible with each other. As shown in FIG. 2, a Windows operating system and a Linux operating system commonly use Master Boot Record (MBR) to manage a volume (disk), and a Solaris operating system uses Volume Table of Contents (VTOC) to manage a volume (disk). Configuration data of the foregoing operating systems is stored in the first sector at the front end of the volume (disk). UNIX operating systems such as Advanced Interactive eXecutive (AIX) and HP-UX use volume management software such as Logical Volume Manager (LVMH) to manage a volume (disk). The UNIX operating systems store the volume management mode at the rear end of the volume (disk).

In the embodiment of the present invention, when a virtualization device discovers an LUN from a storage array, if the LUN is a used LUN inclusive of data, the virtualization device determines the volume management mode of the LUN according to a flag bit of the LUN from the storage array, reads partition information of the LUN according to different volume management modes, obtains the volume management mode of the LUN according to the partition information of the LUN, and records the volume management mode of the LUN into the stitch data.

Step S102: Construct a virtual LUN according to the LUN and the stitch data, and map the virtual LUN to a host to enable read/write access.

The constructing the virtual LUN according to the LUN and the stitch data may include:

(1) reading a flag bit of the LUN from the storage array to obtain partition information of the LUN;

(2) allocating storage space for storing the stitch data in the virtualization device or the storage array; and

(3) writing a data structure to be stored permanently in the stitch data, where the data structure includes:

a. configuration information;

b. log information;

c. version information;

d. check information;

e. feature code from the LUN of the storage array;

f. size of the stitch data;

g. size of a data area from the LUN of the storage array;

h. read/write policy of the virtual LUN; and

i. backup information, where all stitch data is backed up simultaneously to ensure security of the stitch data.

The mapping the virtual LUN to the host to enable the read/write access may be as follows.

After the virtual LUN is constructed, a target module is used to map the virtual LUN to the host to enable the read/write access. The target module is also known as a launcher, and is configured to encapsulate a Small Computer System Interface (SCSI) protocol. The target module includes two types: Fiber Channel (FC) target and internet Small Computer System Interface (iSCSI) target.

Step S103: After the I/O data packet delivered by the host is received, modify the destination address of the I/O data packet according to the stitch data, deliver the I/O data packet to the virtual LUN, and deliver the I/O data packet delivered to the virtual LUN to the storage array according to the stitch data, where an address of the storage array to which the I/O data packet is delivered is the same as the destination address of the I/O data packet before the modification. In the embodiment of the present invention, the host may be an HP-UX minicomputer platform, an AIX minicomputer platform, a Solaris minicomputer platform, or a Personal Computer (PC) server.

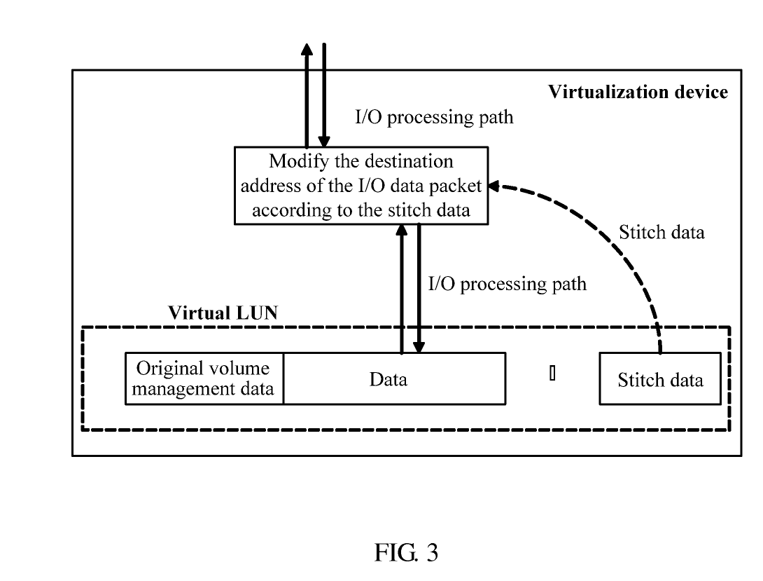

Specifically, as shown in FIG. 3, after receiving the I/O data packet delivered by the host, the virtualization device modifies the destination address of the I/O data packet according to the stitch data, delivers the I/O data packet to the virtual LUN, and virtualizes the access to the original array into the access to the virtual LUN. In this way, the difference caused by volume management modes of different host platforms can be screened.

In an SAN storage architecture, an I/O data packet passes through a network layer and arrives at a storage array. In the embodiment of the present invention, the virtualization device modifies an I/O data packet delivered each time by the host in the network layer, so that an in-band I/O takeover mode is achieved. The host sends the I/O data packet to a network switch device, then the network switch device sends the I/O data packet to the virtualization device, and then the virtualization device processes the I/O data packet and then sends the processed I/O data packet to the storage array. In this way, virtualization management may be performed on LUNs from different application environments.

In the embodiment of the present invention, the stitch data may be stored in an LUN of the storage array. For example, a dedicated LUN is configured in the storage array to store the stitch data, or the stitch data is stored in the virtualization device.

Through the foregoing virtual storage method, the virtualization device records the volume management mode of the LUN from the storage array into the stitch data, constructs the virtual LUN according to the LUN and the stitch data, and maps the virtual LUN to the host to enable the read/write access. After receiving the I/O data packet delivered by the host, the virtualization device modifies the destination address of the I/O data packet according to the stitch data, delivers the I/O data packet to the virtual LUN, and delivers the I/O data packet delivered to the virtual LUN to the storage array according to the stitch data, where the address of the storage array to which the I/O data packet is delivered is the same as the destination address of the I/O data packet before the modification. The embodiment of the present invention achieves storage convergence, and may mask off the difference between different hosts and the difference between volume management modes from different system platforms.

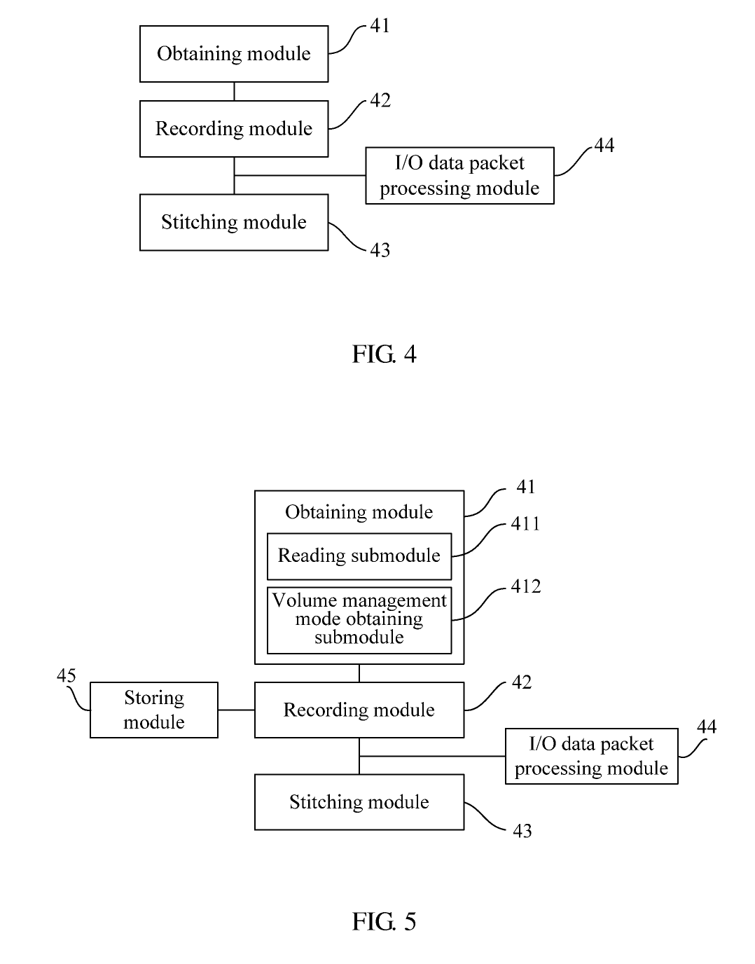

FIG. 4 is a structural diagram of a virtualization device according to an embodiment of the present invention. The virtualization device includes:

an obtaining module 41, configured to obtain a volume management mode of an LUN from a storage array;

a recording module 42, configured to record the volume management mode obtained by the obtaining module 41 in stitch data;

a stitching module 43, configured to construct a virtual LUN according to the LUN and the stitch data obtained by the recording module 42, and map the virtual LUN to a host to enable read/write access; and

an I/O data packet processing module 44, configured to modify a destination address of an I/O data packet delivered by the host according to the stitch data obtained by the recording module 42 after receiving the I/O data packet, deliver the I/O data packet to the virtual LUN constructed by the stitching module 43, and deliver the I/O data packet delivered to the virtual LUN to the storage array according to the stitch data, where an address of the storage array to which the I/O data packet is delivered is the same as the destination address of the I/O data packet before the modification.

The stitching module 43 is specifically configured to read a flag bit of the LUN from the storage array to obtain partition information of the LUN, allocate storage space for storing the stitch data in the virtualization device or the storage array, and write a data structure to be stored permanently into the stitch data to construct a virtual LUN. Afterward, the stitching module 43 uses a target module to map the virtual LUN to the host to enable the read/write access.

As shown in FIG. 5, the obtaining module 41 may include:

a reading submodule 411, configured to read the partition information of the LUN according to the flag bit of the LUN from the storage array; and

a volume management mode obtaining submodule 412, configured to obtain the volume management mode of the LUN according to the partition information read by the reading submodule 411.

The virtualization device may further include:

a storing module 45, configured to store the stitch data obtained by the recording module 42.

Through the foregoing virtualization device, the obtaining module 41 obtains the volume management mode of the LUN from the storage array, the recording module 42 records the volume management mode into the stitch data, and the stitching module 43 constructs the virtual LUN according to the LUN and the stitch data and maps the virtual LUN to the host to enable the read/write access. The I/O data packet processing module 44 modifies the destination address of the I/O data packet delivered by the host according to the stitch data after receiving the I/O data packet, delivers the I/O data packet to the virtual LUN, and delivers the I/O data packet delivered to the virtual LUN to the storage array according to the stitch data, where the address of the storage array to which the I/O data packet is delivered is the same as the destination address of the I/O data packet before the modification. Therefore, the difference caused by volume management modes of different host platforms can be screened, so as to perform virtualization management on LUNs from different application environments.

After reading the foregoing embodiments, those skilled in the art are clearly aware that the present invention may be implemented through hardware, or through software in addition to a necessary universal hardware platform. The technical solutions under the present invention may be embodied in a software product. The software product may be stored in a nonvolatile storage medium (such as CD-ROM, USB flash disk, or removable hard disk), and may include several instructions that enable a computer device (such as PC, server, or network device) to perform the methods according to any embodiment of the present invention.

It is understandable to those skilled in the art that the accompanying drawings are only schematic diagrams of exemplary embodiments, and the modules or processes illustrated in the accompanying drawings are not mandatory for implementing the present invention.

It is understandable to those skilled in the art that the modules in the device according to the embodiment of the present invention may be distributed in the device in the way described, or may be located in one or more devices different from the device described herein. The modules in the foregoing embodiment may be combined into one module, or be further split into multiple submodules.

The serial number of any embodiment above is for ease of description rather than representative of preference order of the embodiment.

The above descriptions are merely several specific embodiments of the present invention, but not intended to limit the present invention. Any modification that can be derived by those skilled in the art shall fall within the protection scope of the present invention.

What is claimed is:

1. A virtual storage method, comprising:
obtaining a volume management mode of a Logical Unit Number (LUN) from a storage array and recording the volume management mode into stitch data;
constructing a virtual LUN according to the LUN and the stitch data, and mapping the virtual LUN to a host to enable read/write access; and
modifying a destination address of an Input/Output (I/O) data packet delivered by the host according to the stitch data after receiving the I/O data packet, delivering the I/O data packet to the virtual LUN, and delivering the I/O data packet which has been delivered to the virtual LUN to the storage array according to the stitch data, wherein an address of the storage array to which the I/O data packet is delivered is the same as the destination address of the I/O data packet before the destination address of the I/O data packet is modified.

2. The method according to claim 1, wherein the obtaining the volume management mode of the LUN from the storage array comprises:
reading partition information of the LUN according to a flag bit of the LUN from the storage array; and
obtaining the volume management mode of the LUN according to the partition information.

3. The method according to claim 2, wherein the reading the partition information of the LUN according to the flag bit of the LUN from the storage array comprises:
determining the volume management mode of the LUN according to the flag bit of the LUN, by judging whether the LUN from the storage array comprises data; and
reading the partition information of the LUN according to the volume management mode of the LUN.

4. The method according to claim 1, wherein:
the stitch data is stored in the LUN of the storage array or stored in a virtualization device.

5. The method according to claim 1, wherein the constructing the virtual LUN according to the LUN and the stitch data comprises:
reading a flag bit of the LUN from the storage array to obtain partition information of the LUN, and allocating storage space for storing the stitch data in the virtualization device or the storage array; and
writing a data structure to be stored permanently in the stitch data to construct the virtual LUN.

6. The method according to claim 4, wherein the constructing the virtual LUN according to the LUN and the stitch data comprises:
reading a flag bit of the LUN from the storage array to obtain partition information of the LUN, and allocating storage space for storing the stitch data in the virtualization device or the storage array; and
writing a data structure to be stored permanently in the stitch data to construct the virtual LUN.

7. The method according to claim 1, wherein the mapping the virtual LUN to the host to enable the read/write access comprises:
using a target module to map the virtual LUN to the host to enable the read/write access.

8. A virtualization device, comprising:
an obtaining module, configured to obtain a volume management mode of a Logical Unit Number (LUN) from a storage array;
a recording module, configured to record the volume management mode obtained by the obtaining module into stitch data;
a stitching module, configured to construct a virtual LUN according to the LUN and the stitch data obtained by the recording module, and map the virtual LUN to a host to enable read/write access; and
an Input/Output (I/O) data packet processing module, configured to modify a destination address of an I/O data packet delivered by the host according to the stitch data obtained by the recording module after receiving the I/O data packet, deliver the I/O data packet to the virtual LUN, and deliver the I/O data packet which has been delivered to the virtual LUN to the storage array according to the stitch data, wherein an address of the storage array to which the I/O data packet is delivered is the same as the destination address of the I/O data packet before the destination address of the I/O data packet is modified.

9. The virtualization device according to claim 8, wherein the obtaining module comprises:
a reading submodule, configured to read partition information of the LUN according to a flag bit of the LUN from the storage array; and
a volume management mode obtaining submodule, configured to obtain the volume management mode of the LUN according to the partition information read by the reading submodule.

10. The virtualization device according to claim 8, further comprising:
a storing module, configured to store the stitch data obtained by the recording module.
